(19) United States
(12) Patent Application Publication
(10) Pub. No.: US 2026/0045708 A1
(43) Pub. Date: Feb. 12, 2026

(54) CONDUCTOR CAPTURE MECHANISM FOR HIGH CABLE DENSITY APPLICATIONS

(71) Applicant: JOHN MEZZALINGUA ASSOCIATES, LLC, Liverpool, NY (US)

(72) Inventors: Leon Gerald MARKETOS, Weedsport, NY (US); Christopher NATOLI, Baldwinsville, NY (US)

(21) Appl. No.: 18/998,655

(22) PCT Filed: Jul. 26, 2023
(86) PCT No.: PCT/US2023/028699

§ 371 Date: Jan. 27, 2025

Related U.S. Application Data
(60) Provisional application No. 63/392,906, filed on Jul. 28, 2022.

(51) Int. Cl. H01R 4/38; H01R 4/62

(52) U.S. Cl. CPC H01R 4/38; H01R 4/62

(57) ABSTRACT

A conductor capture mechanism for a power supply has a frame; a capture block disposed within the frame; an outer ramp disposed within the frame, the outer ramp configured to apply a pressure to a fastening component of a power cable disposed between the capture block and the outer ramp, wherein the pressure is along an outward direction; an inner ramp disposed adjacent to the outer ramp, the inner ramp configured to translate in a longitudinal direction; and a ramp screw disposed adjacent to the inner ramp, the ramp screw configured to, as it is tightened, cause the inner ramp to translate along the longitudinal direction, thereby causing the outer ramp to translate in the outward direction, thereby causing the outer ramp to apply the pressure against the fastening component.

### CROSS REFERENCE TO RELATED APPLICATIONS

This application claims the benefit of priority to U.S. Provisional Application No. 63/392,906, filed Jul. 28, 2022, which is incorporated by reference int its entirety.

### BACKGROUND OF THE INVENTION

### Field of the Invention

The present invention relates to wireless communications, and more particularly, to densely-located power supplies for powering remote radios.

### Related Art

The advent of 5G, both in macro cellular deployments and in dense urban settings, involves the use of multiple frequency bands for communication between cellular antennas and devices or User Equipment (UEs). The use of new and additional frequency bands requires the deployment of additional radios such that more radios are needed to provide coverage in a single area. This requires additional power supplies to power the additional radios at a given cellular site. However, there are space constraints in any cellular base station installation that require power supplies to be more densely packed together in equipment racks.

FIG. 1A illustrates two conventional power cables 105, which may include a compression lug 110 that is installed on a 6AWG cable 120, for example. Compression lug 110 may have a plurality of through holes 115 for a bolt (not shown) to pass through to secure power compression lug 110 to a terminal in a power supply (not shown).

FIG. 1B illustrates a conventional conductor capture solution, which involves inserting compression lug 110 into a terminal in a conventional power supply and securing the compression lug 110 with two bolts. These conventional approaches suffer deficiencies in that a technician must have room to install compression lug 110 and install a nut 120 onto a bolt that engages through holes 115. The room required for access of installation complicates any efforts to densely place power supplies in an equipment rack.

Accordingly, what is needed is a conductor capture mechanism that enables secure installation of power cables while minimizing the access space required for installation, thereby enabling closer spacing—and thus more dense installation—of power cables within power supplies in an equipment rack.

### SUMMARY OF THE DISCLOSURE

An aspect of the present disclosure involves a conductor capture mechanism for a power supply. The conductor capture mechanism comprises a frame; a capture block disposed within the frame; an outer ramp disposed within the frame, the outer ramp configured to apply a pressure to a fastening component of a power cable disposed between the capture block and the outer ramp, wherein the pressure is along an outward direction; an inner ramp disposed adjacent to the outer ramp, the inner ramp configured to translate in a longitudinal direction; and a ramp screw disposed adjacent to the inner ramp, the ramp screw configured to, as it is tightened, cause the inner ramp to translate along the longitudinal direction, thereby causing the outer ramp to translate in the outward direction, thereby causing the outer ramp to apply the pressure against the fastening component.

Another aspect of the present disclosure involves a conductor capture mechanism for a power supply. The conductor capture mechanism comprises a frame; an upper capture block disposed on an upper inner surface of the frame; a lower capture block disposed on a lower inner surface of the frame; an upper outer ramp disposed within an upper portion of the frame, the upper outer ramp configured to apply an upward pressure to a fastening component of a first power cable disposed between the upper capture block and the upper outer ramp; a lower outer ramp disposed within a lower portion the frame, the lower outer ramp configured to apply a downward pressure to a fastening component of a second power cable disposed between the lower capture block and the lower outer ramp; an upper inner ramp disposed adjacent to the upper outer ramp, the upper inner ramp configured to translate in a longitudinal direction; a lower inner ramp disposed adjacent to the lower outer ramp, wherein the upper inner ramp and the lower inner ramp are mechanically coupled together; and a ramp screw disposed between to the upper inner ramp and the lower inner ramp, the ramp screw configured to, as it is tightened, cause the upper inner ramp and the lower inner ramp to translate along the longitudinal direction, thereby causing the upper outer ramp to translate in the upward direction and the lower outer ramp to translate in the downward direction, thereby causing the upper outer ramp to apply the upward pressure against the fastening component of the first power cable and causing the lower outer ramp to apply the downward pressure against the fastening component of the second power cable.

### BRIEF DESCRIPTION OF THE DRAWINGS

FIG. 1A illustrates two conventional power cables.

FIG. 1B illustrates a conventional installation of two power cables.

FIG. 2 illustrates a side view of an exemplary conductor capture mechanism according to the disclosure, illustrated in an installed configuration.

FIG. 3 is a side view and the conductor capture mechanism of FIG. 2, in an initial pre-capture configuration.

FIG. 4 illustrates a rear view of two adjacent exemplary conductor capture mechanisms according to the disclosure.

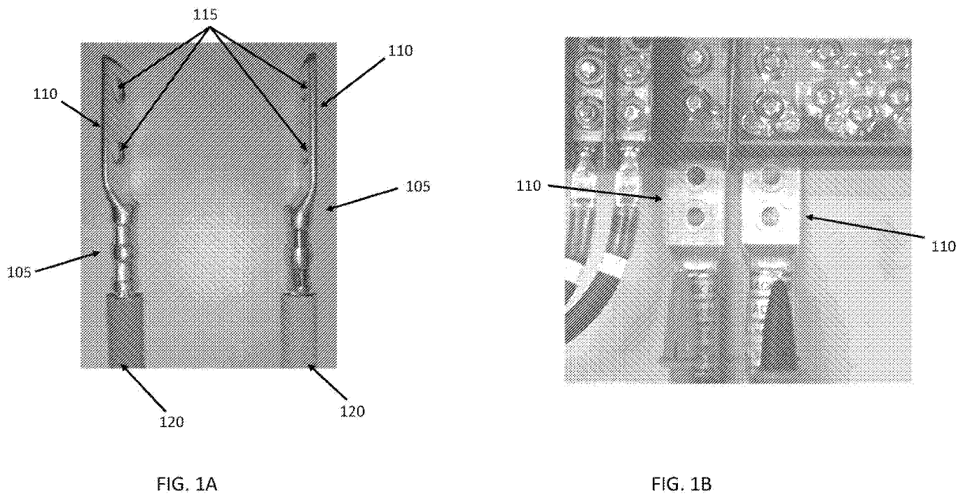

### DESCRIPTION OF EXEMPLARY EMBODIMENTS

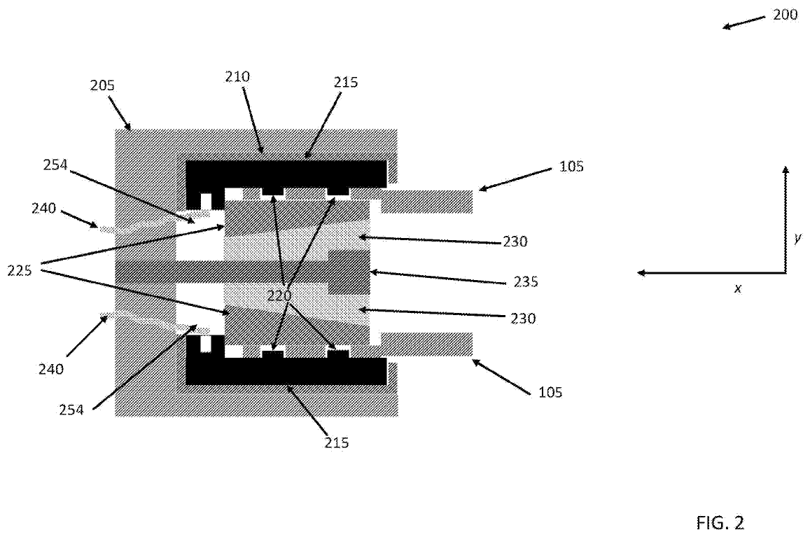

FIG. 2 illustrates a side view of an exemplary conductor capture mechanism 200, for installation of two power cables 105 according to the disclosure. Capture mechanism 200 is illustrated in FIG. 2 in an installed configuration. Capture mechanism 200 is shown with two power cables 105 installed. Conductor capture mechanism 200 has a frame 205, which may be formed of metal such as steel or aluminum; a capture block 215, which may be formed of metal such as plated copper or plated aluminum and may have a plurality of tabs or protrusions 220 configured to engage with through holes 115 of compression lugs 110 of power cables 105. As illustrated, capture mechanism 205 is configured for the capture of two power cables 105. Capture mechanism 205 further includes an insulator boundary 210 disposed between frame 205 and capture block 215. Insulator boundary 210 may be formed of an insulating material such plastic or polycarbonate.

Capture mechanism 200 further includes an outer ramp 225, which may be formed of plated copper or plated aluminum, and which is configured to mechanically engage compression lugs 110 of power cables 105 through a friction contact; and an inner ramp 230, which may be formed of an insulating material such as plastic or polycarbonate, that is disposed on the opposite (inner) side of outer ramp 225.

As illustrated, outer ramp 225 and inner ramp 230 each have a sloped surface where they interface each other. For example, inner ramp 230 has a slope on its outer surface and outer ramp 225 has a slope on its inner surface, and the two slopes are configured to slidably engage with each other.

As used herein, “upper” may refer to a location of a component along the positive y-axis direction, and “upward” may refer to the positive y-axis direction; “lower” may refer to a location of a component along the negative y-axis direction; and “downward” may refer to the negative y-axis direction. It will be understood that the orientations of the x and y axes are arbitrary, and that “upper”, “upward”, “lower”, and “downward” may also refer to an arbitrary coordinate frame and that these terms may be considered describing relative orientations and directions to each other.

Capture mechanism 200 has a ramp screw 235, which pushes inner ramp 230 outward (is the positive and negative y-axis direction) in as ramp screw 235 is tightened and translates in the positive x-axis (or longitudinal) direction. Ramp screw 230 may have a socket head cap to enable easy tightening and securing to metal frame 205. As illustrated in FIG. 2, ramp screw 235 has been inserted and fully tightened.

Inner ramp 230 may be formed of a single piece of insulating material that surrounds ramp screw 230. Outer ramp 225 may be formed of a single piece of insulating material that surrounds inner ramp 230, or outer ramp 225 may be formed of two symmetric components (as illustrated) disposed on either side of outer ramp 225.

Capture mechanism 200 further includes a post 254 that couples each corresponding capture block 215 to a wire 240, which electrically couples corresponding power cable 105 to its respective terminal in the power supply (not shown).

Capture mechanism 200 may have a height along the y-axis (or outward) direction equal to 1U of equipment rack dimension (1.7 inches max). This enables stacking of power supplies (not shown) in an equipment rack such that the installation/removal of power cables 105 may be done for multiple power supplies, and installation/removal of power cables may be done on one power supply without interfering with the power cables of other power supplies in the rack.

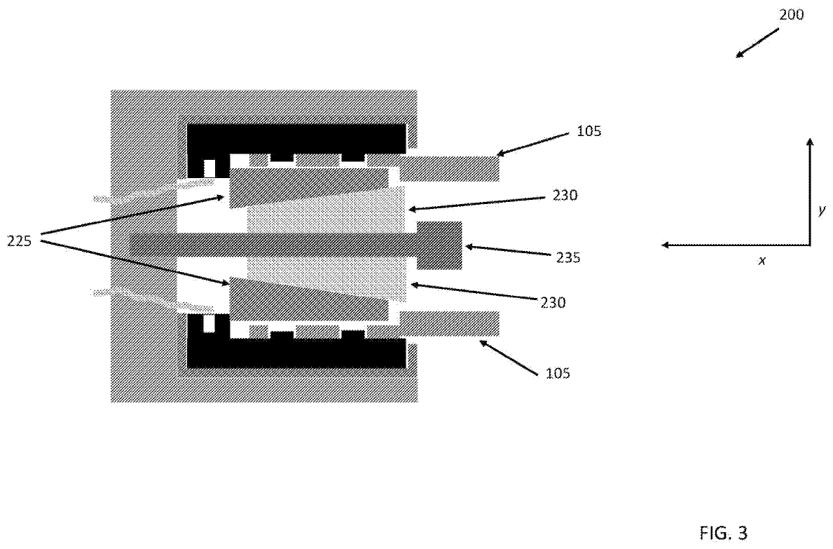

FIG. 3 illustrates capture mechanism 200 in an initial pre-capture configuration. In a pre-capture configuration, ramp screw 235 is loosened to where inner ramp 230 is able to translate outward in the negative x-axis direction, which in turn releases pressure on outer ramps 225, allowing compression lugs 110 of each power cable 105 to be easily inserted to where protrusions 220 of each capture block 215 engage with through holes 115 of compression lugs 110. It will be noted that outer ramps 225 may not translate in the x-direction with translation of ramp screw 235, but that inner ramp 230 may translate accordingly.

Once power cables 105 are inserted, a technician then tightens ramp screw 235, causing ramp screw 235 to translate in the positive x-axis direction until it engages inner ramp 230. And once engaged, inner ramp 230 translates in unison with ramp screw in the positive x-axis direction. As inner ramp 230 translates as described, its outer surface (upper and lower boundary in the y-axis direction) engages with and applies pressure to the inner surface of both outer ramps 225. As this pressure is applied, outer ramps 225 translate outward (in the positive and negative y-axis direction, respectively), pressing against compression lugs 110 of power cables 105. As ramp screw 235 is tightened to completion, inner ramp 230 and outer ramps 225 are in a state of compression, thereby securing compression lugs 110 to their respective capture blocks 215.

Removal of power cables 105 may be done by performing the process described above in reverse—by unscrewing ramp screw 235 until inner ramp 230 translates in the negative x-axis direction, releasing compression with outer ramps 225 until outer ramps 225 disengage from their respective compression lugs 110 to where power cables 105 may be removed.

The materials for inner ramp 230 and outer ramps 225 may be selected so that the friction between them at their interfaces is low enough so that they don't bind when ramp screw 235 is being tightened, and that they are sufficiently rigid to allow compression.

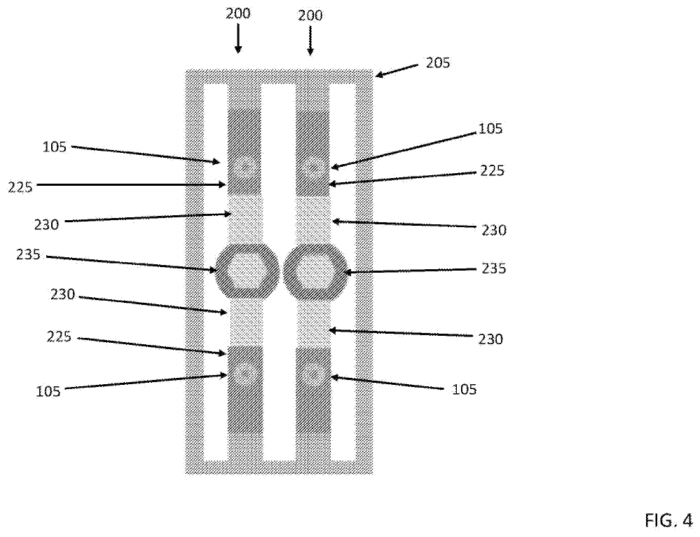

FIG. 4 is a view of two capture mechanisms 200 as illustrated in FIG. 2, but from along the positive x-axis. The two capture mechanisms 200 may share a frame 205, which may have a width of approximately 1.5 inches. Accordingly, multiple iterations of the two capture mechanisms 200 in FIG. 4 may be used for a given power supply in an equipment rack. Further, given the design of each capture mechanism 200, a technician may install/remove power cables for a given capture mechanism 200 without interfering with the power cables of adjacent capture mechanisms (not shown). This is due to easy access to the head of each ramp screw 235 as well as easy access to power cables 105.

Although power cable 105 is described as having a compression lug 110 with a plurality of through holes 115, it will be understood that this is one example of a fastening component for a power cable and that variations are possible and within the scope of the disclosure. As an example, power cable 105 could have a stripped cable end, which is inserted into capture mechanism 200 without a compression lug. Accordingly, capture block 215 may have variations to reflect the fastening component of power cable 105: protrusions 220 may be omitted or have a different shape. Further, although power cable 105 is described above as being a 6AWG cable, it will be understood that other cable gauges are possible and within the scope of the disclosure.

1. A conductor capture mechanism for a power supply, comprising:
a frame;
a capture block disposed within the frame;
an outer ramp disposed within the frame, the outer ramp configured to apply a pressure to a fastening component of a power cable disposed between the capture block and the outer ramp, wherein the pressure is along an outward direction;
an inner ramp disposed adjacent to the outer ramp, the inner ramp configured to translate in a longitudinal direction; and
a ramp screw disposed adjacent to the inner ramp, the ramp screw configured to, as it is tightened, cause the inner ramp to translate along the longitudinal direction, thereby causing the outer ramp to translate in the outward direction, thereby causing the outer ramp to apply the pressure against the fastening component.

2. The conductor capture mechanism of claim 1, wherein the frame comprises one of steel and aluminum.

3. The conductor capture mechanism of claim 1, wherein the capture block comprises one of plated copper and plated aluminum.

4. The conductor capture mechanism of claim 1, wherein the capture block comprises at least one protrusion.

5. The conductor capture mechanism of claim 1, wherein the inner ramp comprises a first ramp on its outer surface, and the outer ramp comprises a second ramp on its inner surface, wherein the first ramp and the second ramp are configured to slidably engage with each other.

6. A conductor capture mechanism for a power supply, comprising:
a frame;
an upper capture block disposed on an upper inner surface of the frame;
a lower capture block disposed on a lower inner surface of the frame;
an upper outer ramp disposed within an upper portion of the frame, the upper outer ramp configured to apply an upward pressure to a fastening component of a first power cable disposed between the upper capture block and the upper outer ramp;
a lower outer ramp disposed within a lower portion the frame, the lower outer ramp configured to apply a downward pressure to a fastening component of a second power cable disposed between the lower capture block and the lower outer ramp;
an upper inner ramp disposed adjacent to the upper outer ramp, the upper inner ramp configured to translate in a longitudinal direction;
a lower inner ramp disposed adjacent to the lower outer ramp, wherein the upper inner ramp and the lower inner ramp are mechanically coupled together; and
a ramp screw disposed between to the upper inner ramp and the lower inner ramp, the ramp screw configured to, as it is tightened, cause the upper inner ramp and the lower inner ramp to translate along the longitudinal direction, thereby causing the upper outer ramp to translate in the upward direction and the lower outer ramp to translate in the downward direction, thereby causing the upper outer ramp to apply the upward pressure against the fastening component of the first power cable and causing the lower outer ramp to apply the downward pressure against the fastening component of the second power cable.

7. The conductor capture mechanism of claim 6, wherein the upper inner ramp comprises an upper first ramp on its outer surface, and the upper outer ramp comprises an upper second ramp on its inner surface, wherein the upper first ramp and the upper second ramp are configured to slidably engage with each other, and wherein the lower inner ramp comprises a lower first ramp on its outer surface, and the lower outer ramp comprises a lower second ramp on its inner surface, wherein the lower first ramp and the lower second ramp are configured to slidably engage with each other.

8. The conductor capture mechanism of claim 6, wherein the frame comprises one of steel and aluminum.

9. The conductor capture mechanism of claim 6, wherein the capture block comprises one of plated copper and plated aluminum.

10. The conductor capture mechanism of claim 6, wherein the capture block comprises at least one protrusion.

11. The conductor capture mechanism of claim 6, wherein the inner ramp comprises a first ramp on its outer surface, and the outer ramp comprises a second ramp on its inner surface, wherein the first ramp and the second ramp are configured to slidably engage with each other.
